(19) United States
(12) Patent Application Publication
(10) Pub. No.: US 2004/0175014 A1
(43) Pub. Date: Sep. 9, 2004

(54) Light-emitting speaker

(75) Inventor: Yong Liu, Jiashan (CN)

Correspondence Address: SYNNESTVEDT & LECHNER, LLP, 2600 ARAMARK TOWER, 1101 MARKET STREET, PHILADELPHIA, PA, 191072950

(73) Assignee: Speaker Electronic (Jiashan) Co., Ltd., Jiashan (CN)

(21) Appl. No.: 10/792,989

(22) Filed: Mar. 4, 2004

(30) Foreign Application Priority Data
Mar. 6, 2003 (CN) 03229317.8

(51) Int. Cl. H04R 1/20; H04R 1/02; F21V 15/00; B60Q 3/04

(52) U.S. Cl. 381/386; 381/388; 362/362

(57) ABSTRACT

Disclosed herein is a light-emitting speaker comprising mainly a loudspeaker and a speaker cabinet in which the loudspeaker is mounted. The loudspeaker itself comprises a chassis, a diaphragm, a voice coil, a magnet, some accessories and decorative material. One or more LEDs are mounted on the cabinet to provide light emitting effect. The said LEDs may be also mounted on any location at the loudspeaker, the inner or outer wall of the cabinet. On the loudspeaker or the cabinet fasterers may be placed to mount the said LEDS. Furthermore, the LEDs can be controlled by either a voice or an electronic controller, or connected to the speaker's audio control circuit to vary the intensity of the light by the sound generated by the loudspeaker. The speaker with LEDs according to the present invention is designed so that the speaker can convert audio signal into sound, and to provide lighting effect while the speaker is functioning. It can be designed to provide variable intensity or flickering lighting effect following the rhythm or intensity of the sound regenerated by the speaker. With the features of LEDs—small size, light weight, good stability, long service life, very small power consumption and small heat generation while they are working, the use of LEDs provide the speaker with both power conservation and safety.

### FIELD OF THE INVENTION

The present invention relates to a structure of speaker cabinet, particularly a speaker cabinet that can emit light.

### BACKGROUND OF THE INVENTION

Generally a speaker is composed of a loudspeaker and a speaker cabinet. The loudspeaker is a device to convert electronic signal to sound, and generally comprises a chassis, a diaphragm, a voice coil and a magnet. When an audio input is passing through the voice coil, by the effect of a magnetic field the voice coil drives the diaphragm to vibrate and reproduce the sound. Nowadays the design of speaker cabinet is mainly focused on enhancing output power, minimizing loss and improving its performance, not much attention is paid to its decorative effect. Apparently it is not enough for people today who is seeking for both performance and sense of beauty.

### SUMMARY OF THE INVENTION

In view of the defects described above, the main objective of the present invention is to provide a speaker with light emitting effect having a simple structure that can be produced with low cost to satisfy people seeking for innovation.

The light-emitting speaker according to the present invention comprises mainly a loudspeaker and a speaker cabinet in which the loudspeaker is mounted. The loudspeaker itself comprises a chassis, a diaphragm, a voice coil and a magnet. One or more LEDs are mounted on the cabinet to provide light emitting effect. The said LEDs may be also mounted on any location at the loudspeaker, the inner or outer wall of the cabinet. On the loudspeaker or the cabinet fasteners may be placed to mount the said LEDS. Furthermore, the LEDs can be controlled by either a voice or an electronic controller, or connected to the speaker's audio control circuit to vary the intensity of the light by the sound generated by the loudspeaker.

The speaker with LEDs according to the present invention is designed so that the speaker can convert electronic signal into sound, and to provide lighting effect while the speaker is functioning. It can be designed to provide variable intensity or flickering lighting effect following the rhythm or intensity of the sound regenerated by the speaker. With the features of LEDs—small size, light weight, good stability, long service life, very small power consumption and small heat generation while they are working, the use of LEDs provide the speaker with both power conservation and safety.

### BREIF DESCRIPTION OF THE DRAWINGS

FIG. 1 illustrates the structure of a light-emitting speaker decorated with LEDs according to the present invention.

FIG. 2 is a sectional view taken along a line A-A in the FIG. 1.

FIG. 3 illustrates another embodiment of the present invention, wherein the LEDs are mounted around the periphery of a side cushion for the diaphragm of the loudspeaker.

FIG. 4 illustrates another embodiment of the present invention, wherein the LEDs are mounted on the spacers for the magnet in the loudspeaker.

FIG. 5 illustrates another embodiment of the present invention, wherein the LEDs are mounted in a transparent magnet cover.

FIG. 6 illustrates another embodiment of the present invention, wherein the LEDs are mounted on the inner walls of the speaker cabinet.

FIG. 7 illustrates another embodiment of the present invention, wherein the LEDs are mounted on the inner wall of the bottom of the speaker cabinet.

FIG. 8 illustrates another embodiment of the present invention, wherein the LEDs are mounted behind the netted cover and logo on the front wall of the speaker cabinet.

FIG. 9 illustrates another embodiment of the present invention, wherein the LEDs are mounted on a speaker cabinet designed in the shape of a fire extinguisher.

FIG. 10 illustrates another embodiment of the present invention, wherein the LEDs are mounted on a speaker cabinet designed in the shape of a missile.

FIGS. 11 through 13 illustrate some further embodiments of the present invention.

### DETAILED DESCRIPTION OF THE PREFERRED EMBODIMENTS

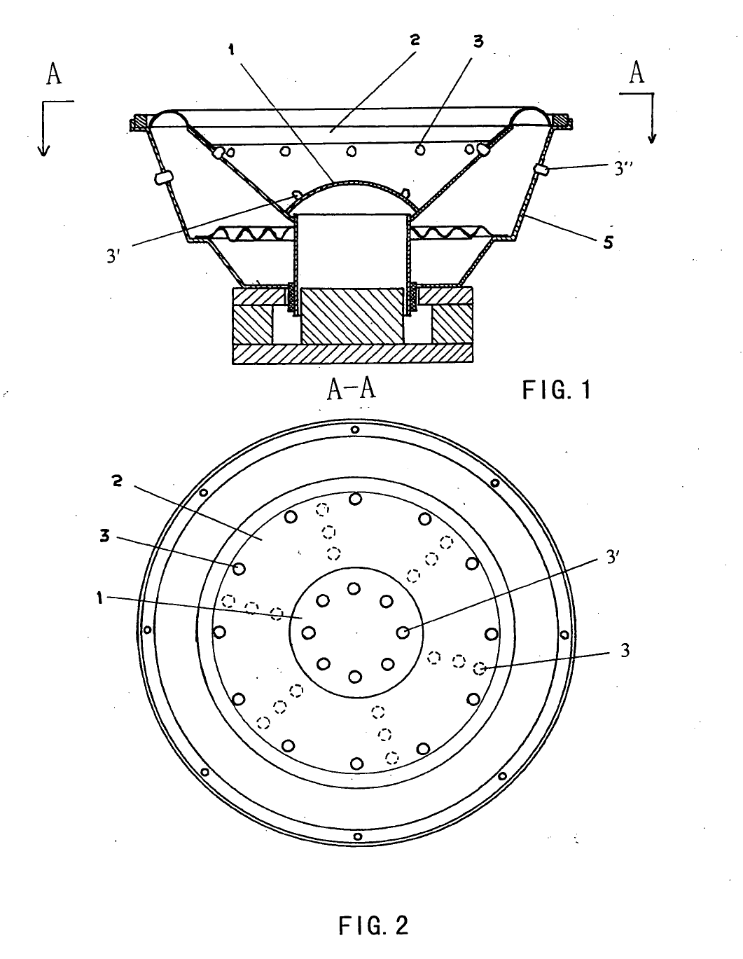

As shown in FIG. 1, the light-emitting speaker decorated with light emitting diodes (“LEDs”) comprises a loudspeaker and a speaker cabinet in which the loudspeaker is mounted. The loudspeaker itself comprises a chassis 5, a diaphragm 2, a voice coil and a magnet. A plurality of LEDs is mounted on the cabinet to provide light emitting effect. The electric power for the LEDs to decorate the cabinet can be supplied by an independent power source, controlled by voice or electronic device.

The LEDs for the present invention can be mounted on different positions on the cabinet.

FIGS. 1 through 5 illustrate examples of positions for mounting of the said LEDs on the loudspeaker, while the cabinet enclosing the loudspeaker comprises a least a part made of transparent material.

Please refer to FIGS. 1 and 2, the said LEDs 3 are mounted on the diaphragm 2 annularly or radially as shown by the dash-lines in FIG. 2. While the speaker is functioning, the diaphragm is vibrated axially; the LEDs may remain fixed or vibrate synchronously to provide a varying light effect.

The said LEDs 3 may be mounted on a dust-proof cover 1 located at the center of the diaphragm 2, as shown with 3′, or around its periphery.

Please refer to FIG. 1, the said LEDs may be mounted on the braces for the support chassis 5, such as in the way shown with 3″ to provide a lighting effect from the back of the loudspeaker.

The said LEDs may be mounted on the back of the diaphragm 2 (not shown in the drawings) for providing a lighting effect through the diaphragm and the dust-proof cover made of transparent or semi-transparent material.

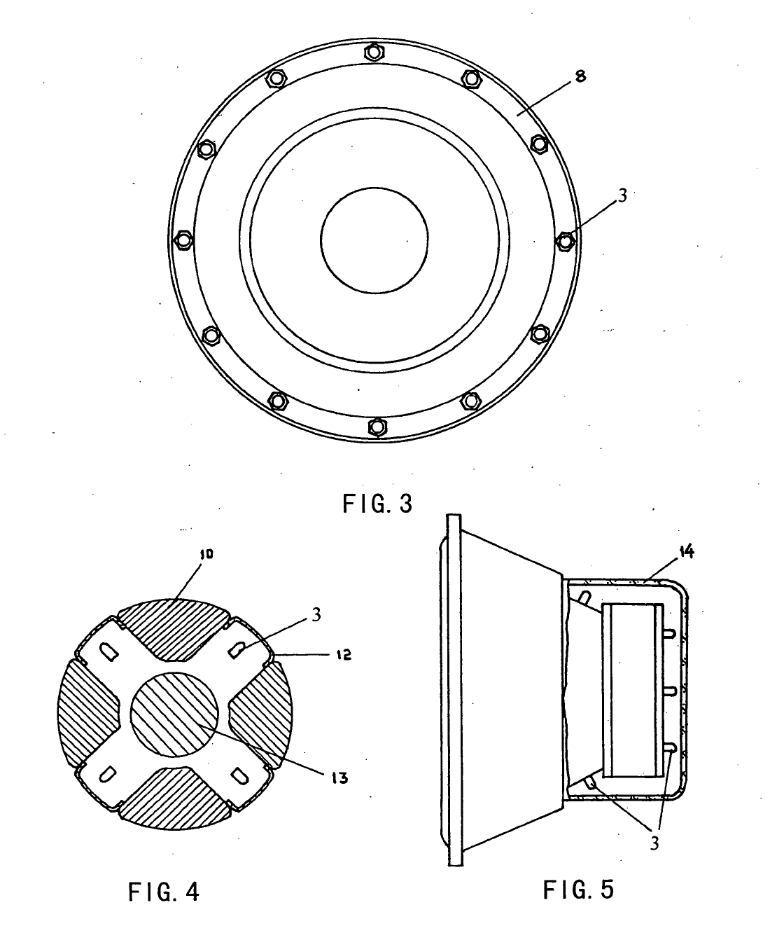

As shown in FIG. 3, the side cushion 8 for the diaphragm is designed with a plurality of holes or spacers for mounting of a LED 3 at each hole or spacer to emit light. The side cushion 8 is transparent for the LEDs to provide lighting effect.

As shown in FIG. 4, the magnet in the loudspeaker is composed of a plurality of magnet blocks. The said LEDs 3 can be mounted on the spacers for these magnet blocks to provide lighting effect through the holes at the dust-proof cover 12.

For loudspeaker designed with a magnet cover, as shown in FIG. 5, the magnet cover 14 may be made of transparent or semi-transparent material for the LEDs 3 mounted on the magnet to emit light through the magnet cover towards its lateral sides and the back.

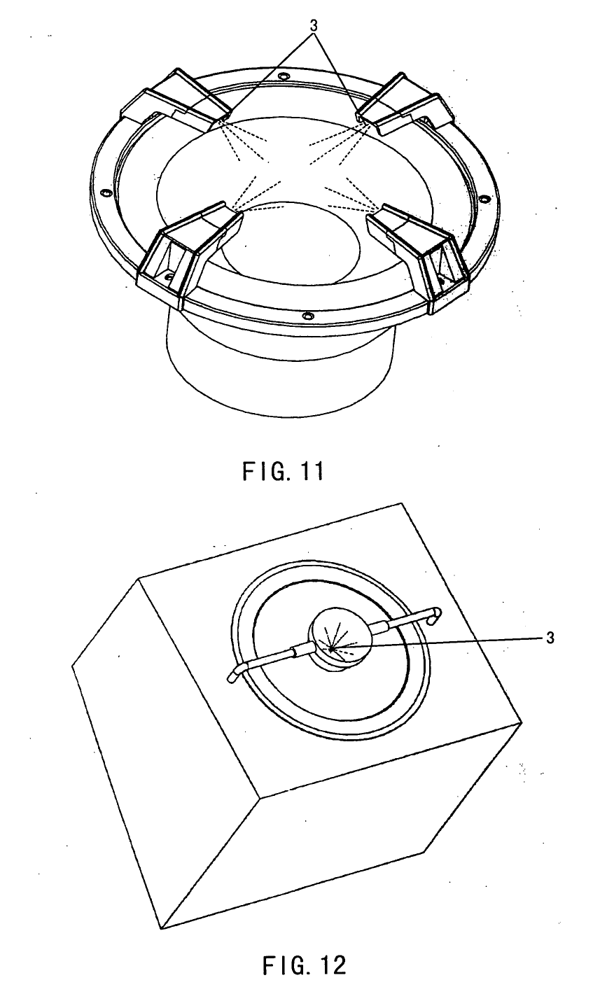

Referring to FIG. 11, the present invention provides a structure having a plurality of chuck around the diaphragm, each for mounting of a LED 3 to emit light towards the center of the diaphragm.

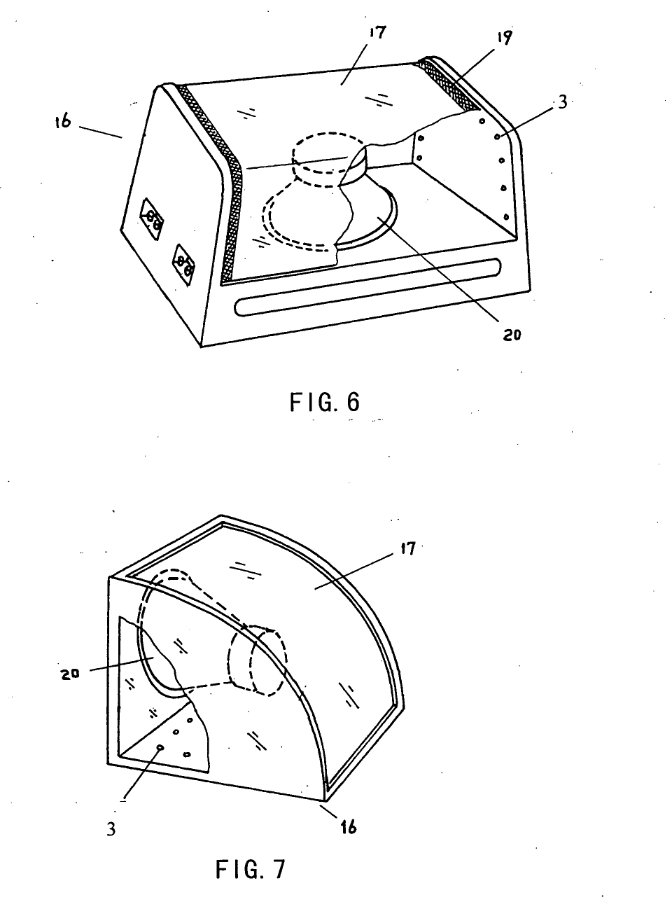

FIGS. 6 through 10 illustrate some other embodiments of mounting the LEDs on the speaker cabinet.

The speaker cabinet 16 shown in FIG. 6 comprises at least a transparent side wall 17, and all the walls of the speaker cabinet 16 are transparent. The said LEDs 3 are mounted on the inner walls of the speaker cabinet to form a light emitting body. To increase intensity of the light, the support chassis and the magnet of the loudspeaker 20 in the speaker cabinet are coated with reflective material such as by chromium-plating so that the light from the LEDs is emitted towards the surface of the loudspeaker and then the light reflected from the loudspeaker is remitted outwards through the transparent cabinet to provide an outstanding decorating effect.

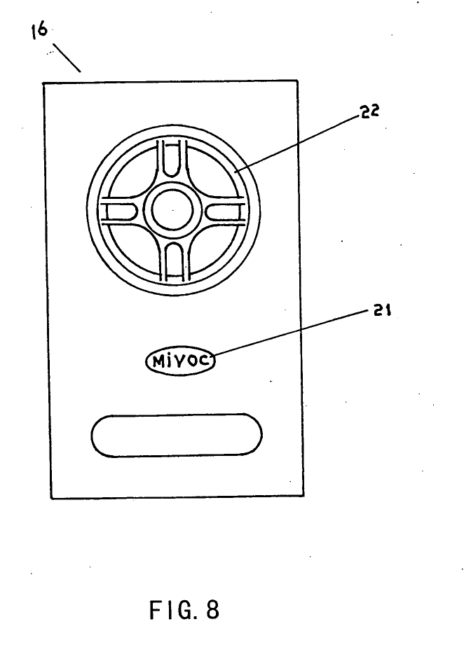

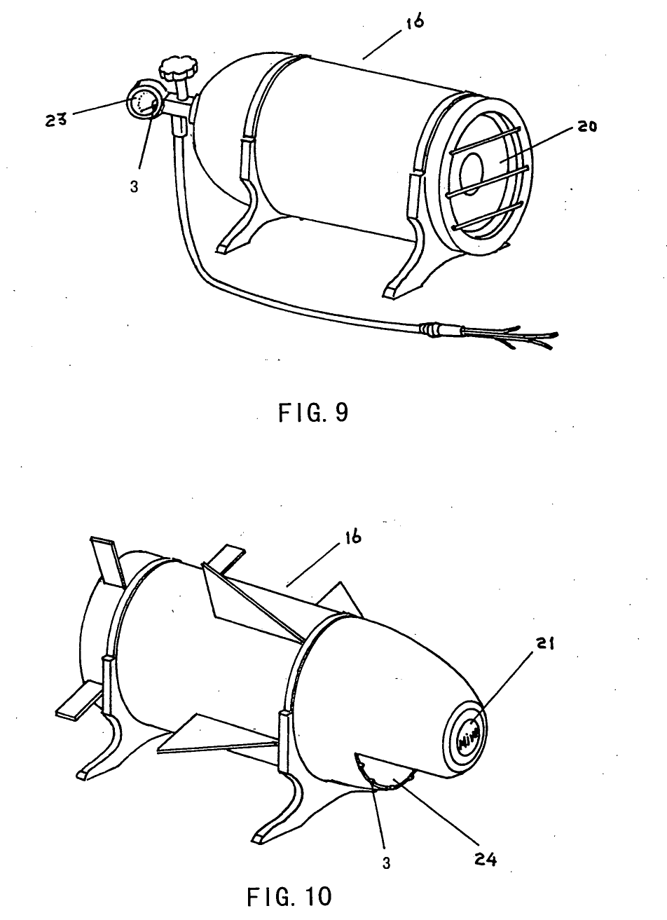

As shown in FIGS. 8 and 10, a transparent logo 21 is fixed to the speaker cabinet 16 and the said LEDs are mounted behind the transparent logo to emphasize the logo by the light emitted from the LEDs.

Furthermore, the said LEDs can be mounted behind other transparent or semi-transparent element designed as a part of the speaker cabinet as shown in FIG. 8. For instance, the LEDs are mounted behind a netted or poriferous cover 22 so that the light from the LEDs can be emitted outwards through the netted or poriferous cover 22. Referring to FIG. 9, a voltmeter 23 is mounted on a speaker cabinet designed with a shape like a fire distinguisher. Within the voltmeter 23 the said LEDs are mounted so that the voltmeter can give a lighting effect while the speaker is functioning. The speaker cabinet may be designed with a support, such as a support 20 shown in FIG. 9, and a transparent logo is mounted on the support as illustrated in FIG. 12 with the said LEDs 3 behind such logo to provide another lighting effect.

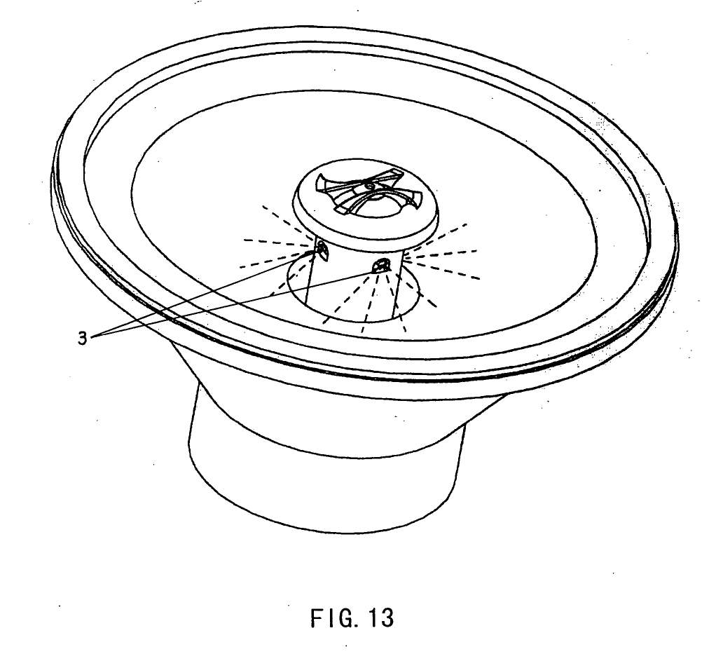

Referring to FIG. 13, the said LEDs 3 can be mounted on a support for the mid and high frequency units in car speaker to emit light toward the diaphragm and netted cover, providing the loudspeaker an overall lighting effect.

Of course, the said LEDs 3 can be mounted on the outer wall of the speaker cabinet directly, as shown in FIG. 10, a missile-shaped speaker cabinet with LEDs along an edge of a chassis 24.

The LEDs for decoration of the speaker cabinet can be of different colors. The speaker cabinet can be mounted with the said LEDs in one color or a combination of different colors to provide different decorative effect.

What is claimed is:

1. A light-emitting speaker comprising a loudspeaker composed of a support chassis, a diaphragm, a voice coil, a magnet, some accessories and decorative material, and a speaker cabinet in which the loudspeaker is mounted with accessories and decorated material on the said cabinet; and characterized by the mounting of one or more light emitting diodes on the speaker.

2. A light-emitting speaker according to claim 1, wherein the said light emitting diodes are mounted on the loudspeaker.

3. A light-emitting speaker according to claim 1, wherein the said light emitting diodes are mounted on the speaker cabinet.

4. A light-emitting speaker according to claim 2, wherein the said light emitting diodes are mounted on the loudspeaker's support chassis, diaphragm, voice coil, magnet and/or its accessories or decorative material.

5. A light-emitting speaker according to claim 3, wherein the said light emitting diodes are mounted on the speaker cabinet's accessories and/or decorative material.

6. A light-emitting speaker according to claim 4, wherein the loudspeaker has a fastener for mounting of each light emitting diode.

7. A light-emitting speaker according to claim 6, wherein the fastener is a chuck extended from the edge of the support chassis.

8. A light-emitting speaker according to claim 3, wherein the speaker cabinet comprises at least a transparent portion and the said LEDs are mounted within the speaker cabinet.

9. A light-emitting speaker according to claim 3, wherein the speaker cabinet is designed with a support with a transparent logo and the said LEDs are mounted behind the logo.

10. A light-emitting speaker according to claim 1, wherein the said LEDs are controlled by a voice or electronic controller circuit.

11. A light-emitting speaker according to claim 2, wherein the said LEDs are controlled by a voice or electronic controller circuit.

12. A light-emitting speaker according to claim 3, wherein the said LEDs are controlled by a voice or electronic controller circuit.

13. A light-emitting speaker according to claim 4, wherein the said LEDs are controlled by a voice or electronic controller circuit.

14. A light-emitting speaker according to claim 5, wherein the said LEDs are controlled by a voice or electronic controller circuit.

15. A light-emitting speaker according to claim 8, wherein the said LEDs are controlled by a voice or electronic controller circuit.

16. A light-emitting speaker according to claim 9, wherein the said LEDs are controlled by a voice or electronic controller circuit.

17. A light-emitting speaker according to claim 1, wherein the said LEDs are connected to the loudspeaker's audio input terminal via a rectifier diode, the audio input is rectified and then sent to the LEDs; or via an electronic controller to control its light emitting rhythm.

18. A light-emitting speaker according to claim 2, wherein the said LEDs are connected to the loudspeaker's audio input terminal via a rectifier diode, the audio input is rectified and then sent to the LEDs; or via an electronic controller to control its light emitting rhythm.

19. A light-emitting speaker according to claim 3, wherein the said LEDs are connected to the loudspeaker's audio input terminal via a rectifier diode, the audio input is rectified and then sent to the LEDs; or via an electronic controller to control its light emitting rhythm.

20. A light-emitting speaker according to claim 4, wherein the said LEDs are connected to the loudspeaker's audio input terminal via a rectifier diode, the audio input is rectified and then sent to the LEDs; or via an electronic controller to control its light emitting rhythm.

21. A light-emitting speaker according to claim 5, wherein the said LEDs are connected to the loudspeaker's audio input terminal via a rectifier diode, the audio input is rectified and then sent to the LEDs; or via an electronic controller to control its light emitting rhythm.

22. A light-emitting speaker according to claim 8, wherein the said LEDs are connected to the loudspeaker's audio input terminal via a rectifier diode, the audio input is rectified and then sent to the LEDs; or via an electronic controller to control its light emitting rhythm.

23. A light-emitting speaker according to claim 9, wherein the said LEDs are connected to the loudspeaker's audio input terminal via a rectifier diode, the audio input is rectified and then sent to the LEDs; or via an electronic controller to control its light emitting rhythm.
